(19) United States
(12) Patent Application Publication
(10) Pub. No.: US 2010/0115061 A1
(43) Pub. Date: May 6, 2010

(54) SERVER SYSTEM, SERVER APPARATUS, PROGRAM AND METHOD

(75) Inventors: Hideki Tai, Kanagawa-ken (JP); Hironobu Takagi, Kanagawa-ken (JP)

Correspondence Address: IBM CORPORATION, T.J. WATSON RESEARCH CENTER, P.O. BOX 218, YORKTOWN HEIGHTS, NY, 10598, US

(73) Assignee: INTERNATIONAL BUSINESS MACHINES CORPORATION, Armonk, NY (US)

(21) Appl. No.: 12/607,499

(22) Filed: Oct. 28, 2009

(30) Foreign Application Priority Data
Oct. 30, 2008 (JP) 2008280386

(51) Int. Cl. G06F 15/16

(52) U.S. Cl. 709/219

(57) ABSTRACT

Provided is a server system that transmits a content back in response to receipt of a request message for the content, the server system including: a request receiver for receiving the request message for the content; a delay notification unit for replying to a request source with a delay message indicating that a transmission of the content is to delay; a restoration unit for restoring the content specified by the request message; and a content transmitter for transmitting the restored content back to the request source.

### CROSS REFERENCE TO RELATED APPLICATION

This application claims priority under 35 U.S.C. §119 from Japanese Patent Application No. 2008-280386 filed Oct. 30, 2008, the entire contents of which are incorporated by reference herein.

### BACKGROUND OF THE INVENTION

1. Field of the Invention

The present invention relates to a server system, a server apparatus, a program and a method for delivering content. More particularly, the present invention relates to transmitting and receiving web content.

2. Description of the Related Art

A hypertext system links and associates a plurality of documents with each other which are scattered on the Internet and/or intranets or created respectively by a large number of people. This allows a large number of people to share various information, knowledge and experience through Web pages on the Internet and/or the intranets. For example, Wikipedia™, which is an aggregation of Web pages written by ordinary people respectively for index words, has grown to the largest encyclopedia aggregating human knowledge.

In the hyperlink text system, however, an occurrence of a broken link is a large problem. In other words, when a Web page of link destination, which is linked from a certain Web page, is moved or archived, following the link does not allow the Web page of link destination to be displayed.

Japanese Patent Application Publication No. 2000-194643 discloses an apparatus that makes a Web page at a certain point in the past accessible. Upon receipt of a URL including a time stamp, the apparatus searches for a Web page corresponding to the time stamp from an archive. The apparatus then updates the hyperlink embedded in the Web page so as to include the time stamp, and then, sends the Web page back to the client.

Japanese Patent Application Publication No. 2005-148861 discloses an information acquisition apparatus that enables the following of a link to an archived Web page. The information acquisition apparatus searches for or browses a desired Web page by requesting necessary information from a Web archive, and embeds an address of a Web archiving server in a URL of link destination designated on the identified Web page. Then, the information acquisition apparatus requests the Web page to the Web archiving server on the basis of the address and acquires the Web page of link destination from the Web archive.

Japanese Patent Application Publication No. 2001-282609 discloses a Web page acquisition server. The Web page acquisition server acquires and retains a Web page source from a Web server in accordance with various acquisition conditions (such as a time related condition, or a deadline) specified by a Web page acquisition request received from a user terminal. Then, the Web page acquisition server forwards the Web page source to the user terminal.

Shashank Sharma, in “Firefox Hacks: Firefox Extension restores a broken link page, (link-kire page wo fukkatsushite kureru Firefox Extention” (Jun. 22, 2008, IT Media Enterprise, www.itmedia.co.jp/enterprise/articles/0806/22/news002.html) (searched on Sep. 10, 2008), describes a function that is an extension of a browser that operates on a terminal device. Upon receipt of a 404 error (“404,” “HTTP 404 Not Found,” “HTTP 404 Error,” “404 Error,” “404 Not Found,” or “404 File Not Found”) as a response to a request for a broken link page, the extension acquires a cached Web page by accessing a cache site of Web pages and then displays the Web page that has been cached.

SAP, “SAP ArchiveLink: Summary (gaiyo),” SAP help.sap.com/saphelp_{—}40b/helpdata/ja/d7/e21b6a408e11d1896b0000e8322d00/content.htm (searched on Sep. 10, 2008), describes a technique for enabling access to an archive document from an application of SAP R/3™

The aforementioned conventional techniques allow an archived Web page to be accessed by clearly designating the archive destination, or expect a Web page to be cached in a cache site in a case where a link to the Web page is broken. However, in a case where a link to a Web page is broken for reasons such as because the Web page is moved to an archive, any of the conventional techniques cannot ensure to transmit the Web page back in response to an access request using the link. Accordingly, it may be difficult for users to gather necessary information by following links.

The aforementioned problem is considered to draw a lot of attention in the IT industry in the future. Recent prevalence of techniques for using documents for Web-based collaboration in recent years can be cited. Documents for business use such as word processor documents, spreadsheets and presentation documents are shared on the Web. These documents are considered to be integrated into a hypertext system in the future. While these documents for business use need to be permanently accessible, the storage capacity of storage devices of a Web server is limited.

Rapid increase of multimedia contents can be cited. It has become common to provide multimedia contents such as video and sound on Web sites not only for the purpose of entertainment but also for the purposes of advertisement, education as well as handing down knowledge within an entity such as a corporation. However, an extremely large storage space is required for storing the multimedia content. Global warming and the prevalence of green IT is associated with the draw of attention as well. In order to promote green IT, not frequently accessed contents are desirably moved from a hard disk drive to a storage device that consumes less energy such as a backup tape drive.

### SUMMARY OF THE INVENTION

The present invention provides a server system that transmits content back in response to receipt of a request message for the content. The server system includes: a request receiver for receiving the request message for the content; a delay notification unit for replying to a request source with a delay message indicating that transmission of the content is to delay; a restoration unit for restoring the content specified by the request message; and a content transmitter for transmitting the restored content back to the request source. The present invention also provides a program and a method that are related to the server system.

The present invention further provides a server apparatus that receives a request message for content from a terminal device of a user. The server apparatus includes: a request receiver for receiving the request message for the content; a delay notification unit for replying to a request source with a delay message indicating that transmission of the content is to delay; and a restoration instruction unit for issuing an instruction for restoring the content specified by the request message. The present invention also provides a program and a method that are related to the server apparatus.

Note that the above brief description of the invention does not list all the necessary features of the present invention. In addition, sub-combinations of a group of these features may also constitute the invention.

### BRIEF DESCRIPTION OF THE DRAWINGS

FIG. 1 shows a server system 10 according to a present invention together with terminal devices 100 and a network 120.

FIG. 2 shows a communication flow according to the present invention.

FIG. 3 shows a configuration of a server apparatus 110 according to the present invention.

FIG. 4 shows an example of a status table to be stored in a table storage unit 330 according to the present invention.

FIG. 5 shows a content transmission processing flow of server apparatus 110 according to the present invention.

FIG. 6 shows a content restoration processing flow of server apparatus 110 according to the present invention.

FIG. 7 shows an archive instruction processing flow of server apparatus 110 according to the present invention.

FIG. 8 shows an archive completion processing flow of server apparatus 110 according to the present invention.

FIG. 9 shows a configuration of an archive management device 130 according to the present invention together with an archive storage device 140.

FIG. 10 shows a content restoration processing flow of archive management device 130 according to the present invention.

FIG. 11 shows an archive processing flow of archive management device 130 according to the present invention.

FIG. 12 shows an example of a hardware configuration of a computer 1900 according to the present invention.

### DETAILED DESCRIPTION OF THE PREFERRED EMBODIMENTS

For a more complete understanding of the present invention and the advantage thereof, reference is now made to the following description taken in conjunction with the accompanying drawings.

Hereinafter, the present invention will be described by using embodiments. The embodiments to be described below do not limit the present invention defined by the scope of the claims and not all the combinations of the features described in the embodiments are essential to the solving means of the present invention.

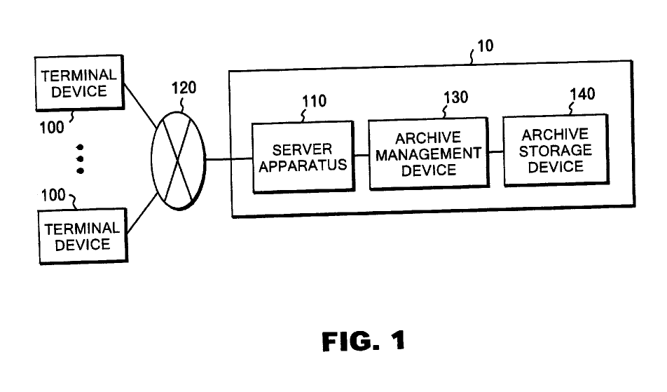

FIG. 1 shows a server system 10 together with terminal devices 100 and a network 120 according to the present embodiment. Server system 10 according to the present embodiment is connected to one or a plurality of terminal devices 100 via network 120 such as the Internet and an intranet. In response to receipt of a request message for content from a terminal device 100, server system 10 transmits the content back. Here, even in a case, for example, where the content has been moved to an archive, server system 10 restores the content from the archive upon receipt of the acquisition request for the content and then transmits the content back to the terminal device 100. Accordingly, even after the content has been moved to an archive, access can be made to the content restored after a certain period of time such as five minutes, five hours or one day. In other words, a so-called “eternal link” can be accomplished.

Server system 10 includes a server apparatus 110, an archive management device 130 and an archive storage device 140. Server apparatus 110 is a Web server, for example. In response to receipt of a request message for content from a terminal device 100, server apparatus 110 transmits back the content stored in server apparatus 110 in a case where the content is stored therein. On the other hand, in a case where the content has been moved and archived in archive management device 130 or archive storage device 140, server apparatus 110 restores the content by transmitting a restoration instruction to archive management device 130 and transmits the restored content back to terminal device 100.

Archive management device 130 functions as a storage apparatus in combination with archive storage device 140. Upon receipt of an instruction to archive content from server apparatus 110, archive management device 130 stores the specified content in archive storage device 140. Then, upon receipt of an instruction to restore content from server apparatus 110, archive management device 130 restores the content from archive storage device 140 and then transmits the restored content back to server apparatus 110. Archive storage device 140 is an example of a second storage device and stores archives of contents therein.

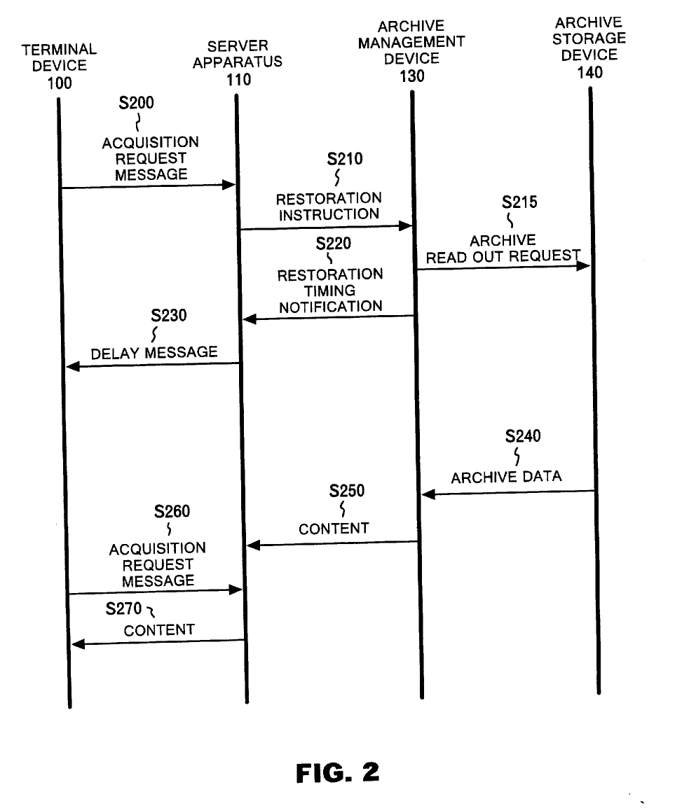

FIG. 2 shows an overview of a communication flow according to the present embodiment.

A terminal device 100 transmits a request message for content to server apparatus 110 (S200). Here, “content” refers to a Web page, a document in a form of an HTML or XML, a Web service, or a file of various types such as audio, music, an image or video, and also refers to data collectively including a plurality of these contents. The request message for content may be, for example, an HTTP request, an FTP request, or a SOAP request message for requesting processing of a Web service. The request message for content may include an identifier for identifying the content such as a URI as information globally specifying the storage location of the content. As the information globally specifying the storage location of content, a URL specifying the content location itself may be used, or a URN specifying the content name may be used.

The terminal device 100 transmits a request message for a target content in the following cases, for example, where a user inputs a URI on a browser, a user selects a hyperlink on a displayed Web page, a URI of an image to be displayed on a Web page is described in an HTML source of the Web page that is to be displayed, a program being executed on the terminal device 100 specifies an URI and issues an acquisition request for the content. A description of how the request message for a content that is transmitted by the terminal device 100 is forwarded to server apparatus 110 on the basis of an URI will be omitted herein because it is a known technique.

In a case where the specified content has been moved to and archived in archive management device 130 and archive storage device 140, server apparatus 110 transmits a restoration instruction for the content to archive management device 130 (S210). Upon receipt of the restoration instruction for the content, archive management device 130 transmits an archive read-out instruction to archive storage device 140 (S215), and reads out archive data in which the content is archived (S240). Then, archive management device 130 restores the content of access target from the archive data and transmits the restored content back server apparatus 110 (S250).

Here, the process of restoring the content from archive storage device 140 and then transmitting the restored content back to the terminal device 100 requires a longer time than the process of transmitting back a content stored in server apparatus 110. This is because archive storage device 140 is used for the purpose of archiving and storing contents stored in the storage device within server apparatus 110, and therefore is required to have a large capacity as a trade-off with access time. The access time thereof is longer than that of the storage device within server apparatus 110 as a drawback. For this reason, in a case where the content is restored from archive storage device 140 and then transmitted back to the terminal device 100, the user of the terminal device 100 has to wait. In this respect, before the restored content is transmitted back, archive management device 130 notifies server apparatus 110 of estimated timing of restoration at which archive management device 130 can restore the content of access target and then transmit the restored content back (S220).

Upon receipt of the notification of the timing of restoration, server apparatus 110 transmits a delay message notifying the terminal device 100 as the request source of a delay of content transmission and of the timing of restoration (S230). Upon receipt of this message, the terminal device 100 displays to the user, for example, that the transmission of the content requested by the user delays and/or that the content becomes accessible at the timing of restoration notified by the delay message.

Upon receipt of a request message for the content again from the terminal device 100 after the restoration of the content (S260), server apparatus 110 transmits the restored content back (S270). Upon receipt of this, the terminal device 100, for example, displays to the user the transmitted content.

According to server system 10 described above, even in a case where content is stored in archive storage device 140, the content can be restored from archive storage device 140 and transmitted back to the request source upon receipt of a request message for the content. In addition, because the processing of transmitting back a content stored in archive storage device 140 requires some time, server system 10 replies to terminal device 100 with a delay message prior to the transmission of the content, and notifies the user of the timing of restoration indicating that the content can be restored in 12 minutes, for example. A typical user usually can afford to wait for only a short period of time such as five or ten minutes after clicking on a hyperlink on a Web page, and therefore cancels the attempt to access the link destination thereafter because the user thinks that the link is broken, or server trouble occurs. According to server system 10, the delay message is transmitted once as a reply within a relatively short period of time such as a few seconds after the receipt of the request message for the content, thereby leading the user to surely access the link destination.

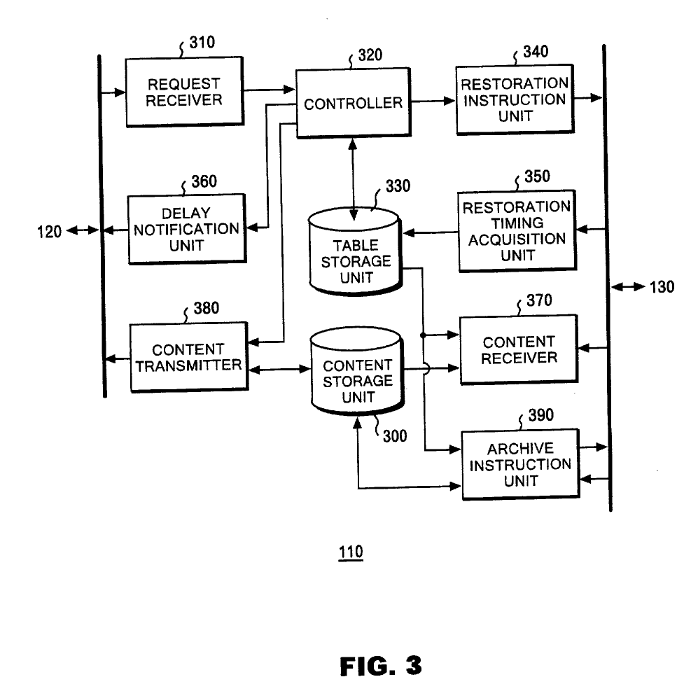

FIG. 3 shows a configuration of server apparatus 110 according to the present embodiment. Server apparatus 110 receives a request message for content from terminal device 100 of the user, then instructs archive management device 130 to restore the content as appropriate, and then transmits back the content of an access target. Server apparatus 110 includes a content storage unit 300, a request receiver 310, a controller 320, a table storage unit 330, a restoration instruction unit 340, a restoration timing acquisition unit 350, a delay notification unit 360, a content receiver 370, a content transmitter 380 and an archive instruction unit 390.

Content storage unit 300 is an example of a first storage device and includes a storage area the location of which is specified by a request message. Content storage unit 300 may be a hard disk drive (HDD) or a solid state drive (SSD), for example. The request receiver 310 receives a request message for content. Controller 320 manages table storage unit 330 and also determines whether or not the content specified by the request message has been moved from content storage unit 300 to archive storage device 140 and then stored therein. Then, in a case where the content has been moved to and stored in archive storage device 140, controller 320 instructs delay notification unit 360 to transmit a delay message and also instructs restoration instruction unit 340 to restore the content. Furthermore, in a case where the content can be transmitted back, controller 320 instructs content transmitter 380 to transmit the content back.

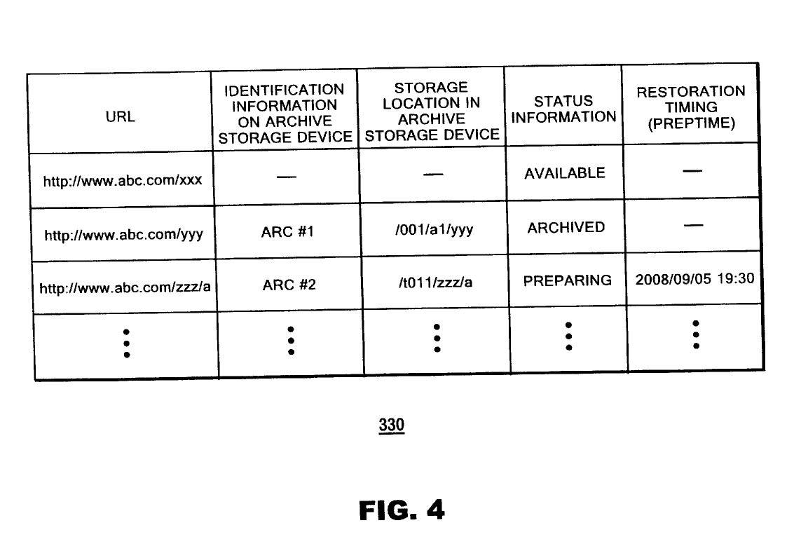

Table storage unit 330 stores a status table in which pieces of status information are registered in association with a plurality of contents, respectively. The status information indicates whether or not to delay content transmission. As will be described later in relation to FIG. 4, each of the pieces of status information on the contents may be, for example, any one of “AVAILABLE” (accessible), “PREPARING” (in preparation) and “ARCHIVED” (in archive). “AVAILABLE” (accessible) indicates that the corresponding content can be transmitted back from content storage unit 300 without delay. “PREPARING” (in preparation) indicates that the content is in the restoration process. “ARCHIVED” (in archive) indicates that the content is stored in archive storage device 140 and that the transmission of the content is to be delayed.

Upon receipt of an instruction from controller 320, restoration instruction unit 340 transmits to archive management device 130 a restoration instruction for restoring the content specified by the request message. Restoration timing acquisition unit 350 acquires the timing of restoration of the content by receiving a restoration timing notification for the content as a subject of the restoration instruction from archive management device 130. Then, restoration timing acquisition unit 350 updates the status table to reflect the acquired timing of restoration.

Upon receipt of the instruction from controller 320, delay notification unit 360 transmits back, to the request source, a delay message indicating that the transmission of the content is to delay. In this embodiment, in a case where controller 320 determines that the content specified by the request message has been moved from content storage unit 300 to archive storage device 140 and stored therein, delay notification unit 360 replies with the delay message. Instead, delay notification unit 360 may also reply with the delay message in a case where the load on server apparatus 110 is not less than a reference value (such as a case where a number of request messages being processed by server apparatus 110 is not less than a reference value). Delay notification unit 360 may also transmit the delay message once for all of the request messages.

Content receiver 370 receives, from archive management device 130, the content restored by archive management device 130 in accordance with the restoration instruction, and then stores the restored content in the original storage location of the content in content storage unit 300. Then, content receiver 370 changes the status information on the content to “AVAILABLE” indicating that the content is available or already restored. Upon receipt of a transmission instruction for the content from controller 320 in accordance with the restoration of the content of the access target, content transmitter 380 transmits the restored content back to terminal device 100 as the request source.

Archive instruction unit 390 selects content to be moved to and stored in archive storage device 140 from contents stored in content storage unit 300 and then instructs archive management device 130 to store the selected contents. Then, in response to receipt of a notification from archive management device 130 indicating that the storing of the contents has been completed, archive instruction unit 390 deletes the already archived contents from content storage unit 300.

FIG. 4 shows an example of the status table to be stored in table storage unit 330 according to the present embodiment. Table storage unit 330 therein respectively stores, in association with a plurality of contents, pieces of content identification information each identifying a content or a storage location of the content, pieces of identification information on archive storage devices 140, storage locations within each of the archive storage devices 140, the pieces of status information, and the timings of restoration of contents.

The URL field stores a URL globally specifying a storage location of a content as an example of a storage location of the content in content storage unit 300 or a piece of content identification information. The two fields of the identification information on archive storage devices 140 and the storage location within corresponding archive storage device 140 are used as an example of archive location information indicating a storage location in an archive destination in a case where contents are archived. These two fields store archive storage device 140 of archive destination and the storage location of the archive destination in archive storage device 140 for content that has been moved to and stored in one or any one of at least two archive storage devices 140 from a storage area in content storage unit 300 within server apparatus 110. The status information field stores the status of the corresponding content. The restoration timing field stores the estimated timing of restoration (also represented as “PREPTIME”) at which the content can be restored and then transmit the restored content back.

In FIG. 4, because the status of the content indicated by “http://www.abc.com/xxx” is “AVAILABLE,” the content has been stored in content storage unit 300. Upon receipt of a request message for the content, server apparatus 110 transmits back the content in content storage unit 300 without a delay message.

Moreover, because the status of the content indicated by “http://www.abc.com/yyy” is “ARCHIVED,” the content has been moved to archive storage device 140 identified with “ARC#1” and has been stored at the storage location indicated by “/001/al/yyy” within identified archive storage device 140. Upon receipt of a request message for the content, server apparatus 110 replies with a delay message and also instructs archive management device 130 to restore the content.

Furthermore, because the status of the content indicated by “http://www.abc.com/zzz/a” is “PREPARING,” the content is in the restoration process from the storage location indicated by “/t011/zzz/a” of archive storage device 140 identified with “ARC#2.” The restoration of the content is planned to be completed and to become available for transmission by 19:30 on Sep. 5, 2008. Upon receipt of a request message for the content, server apparatus 110 replies with a delay message.

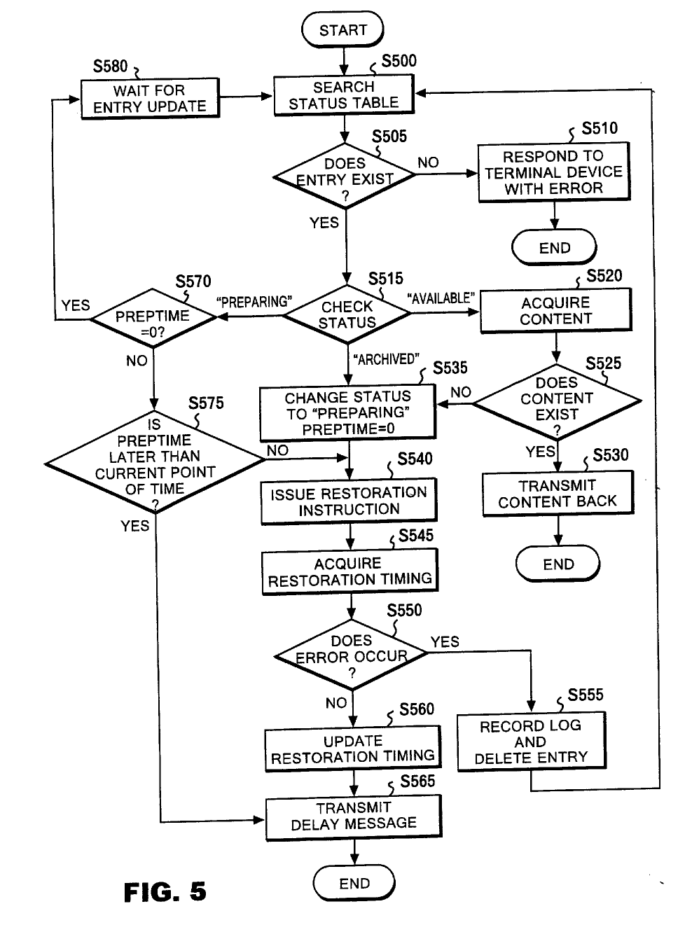

FIG. 5 shows a content transmission processing flow of server apparatus 110 according to the present embodiment. Server apparatus 110 receives one or a plurality of request messages for content from each of a plurality of terminal devices 100. Server apparatus 110 performs the processing shown in FIG. 5 for each of the request messages.

Archive management device 130 in server apparatus 110 receives a request message for content and then provides the message to controller 320. Controller 320 searches the status table in table storage unit 330 by use of information included in the request message as a key, that is, the storage location of the content or the content identification information (step S500). In a case where an entry corresponding to the content specified by the request message does not exist in the status table (S505: NO), controller 320 determines that the content does not exist or that the content is not accessible from an external device. Upon receipt of this determination, content transmitter 380 transmits an error response message to terminal device 100 (S510).

In a case where the entry corresponding to the content specified by the request message exists in the status table, controller 320 checks the status information of the entry (S515). In a case where the status information shows “AVAILABLE,” controller 320 instructs content transmitter 380 to transmit the content back. In response to this, content transmitter 380 reads out the content of access target from content storage unit 300 (S520), and then transmits the content back to the request source (S530) on the condition that the content exists (S525: YES). Then, server apparatus 110 ends the content transmission processing for the request message. On the other hand, in a case where the content does not exist in content storage unit 300, content transmitter 380 proceeds the processing to S535 for attempting to acquire the content from archive storage device 140 (S525: NO).

In a case where the status information shows “ARCHIVED” in S515, controller 320 changes the status information of the entry corresponding to the content to “PREPARING,” and also sets the timing of restoration for the entry to an invalid value (for example, “0”) (S535). Next, controller 320 passes to restoration instruction unit 340 the identification information for archive storage device 140, and the storage location in archive storage device 140, which are the archive destination of the content, and then issues an instruction for restoring the content (S540). Controller 320 may additionally pass the storage location of or the content identification information for the content to restoration instruction unit 340 as the information for identifying the content. Upon receipt of this, restoration instruction unit 340 transmits a restoration instruction including these pieces of information to archive management device 130.

Next, restoration timing acquisition unit 350 acquires the timing of restoration transmitted from archive management device 130 as a reply in response to the restoration instruction (S545). In a case where an error response is received for the restoration instruction due to a case, for example, where the content is not stored in archive storage device 140 (S550: YES), controller 320 records an error in a log while deleting the corresponding entry from the status table (S555), and then proceeds the processing to S500. Server apparatus 110 replies to terminal device 100 of the request source with an error response (S510) because the corresponding entry no longer exists due to the processing (S500, S505).

On the other hand, in a case where the restoration instruction is normally received and the timing of restoration is then received (S550: NO), content receiver 370 updates the timing of restoration for the corresponding entry in the status table in table storage unit 330 to be the timing of restoration received from archive storage device 140 (S560). Here, in a case where restoration timing acquisition unit 350 receives from achieve management device 130 timing information at which archive management device 130 ends the restoration or timing information at which archive management device 130 transmits back the restored content, restoration timing acquisition unit 350 may add a margin for assuring the transmission of the content from server apparatus 110 to the received timing of restoration and then store the timing of restoration timing in the status table.

When the timing of restoration is updated, controller 320 reads out and then passes the timing of restoration for the entry to delay notification unit 360. In response to this, content transmitter 380 transmits a delay message to terminal device 100 of the request source (S565) and then ends the processing shown in FIG. 5.

This delay message is used for displaying some information for the user of terminal device 100 which transmitted the request message. The information is the period of time required for preparing the content, or the date or time at which the preparation of the content is completed. Upon receipt of this delay message, terminal device 100 of the request source displays the period of time required for preparing the content (five minutes later, five hours later, one day later, for example), or the date or time at which the preparation of the content is completed (19:30 on Sep. 5, 2008, for example). As an example of such delay message, delay notification unit 360 may transmit as the reply, instead of the Web page data of the content, Web page data for displaying the period of time required for preparing the content or the date or time at which the preparation of the content is completed.

Instead of the aforementioned delay message, a message only indicating delay of the transmission of the content may be displayed for the user of terminal device 100 which has transmitted the request acquisition message. If the period of time required for preparing the content or the date or time at which the preparation of the content is completed is not transmitted back to terminal device 100, the timing of restoration does not have to be received from archive management device 130. Accordingly, content transmitter 380 can transmit a delay message to the request source before transmitting a restoration instruction to archive storage device 140 or before receiving an acknowledgement for the restoration instruction from archive management device 130.

In a case where the status information is “PREPARING” in S515, controller 320 determines whether or not the status table is updated after the timing of restoration is received from archive management device 130. Specifically, for example, controller 320 determines whether or not the timing of restoration has not been updated and still shows an invalid value (S570). In a case where the status table is not updated, that is, a case where the timing of restoration shows an invalid value (S570: YES), controller 320 waits for the restoration timing of the entry in the status table to be updated (S580) and then proceeds the processing to step S500. In this manner, controller 320 repeats the processing of FIG. 5 on the basis of the updated timing of restoration.

In a case where the timing of restoration for the entry is updated (S570: NO), and also the timing of restoration is later than the current point of time (S575: YES), the controller causes delay notification unit 360 to transmit a delay message (S565). On the other hand, in a case where the timing of restoration has already passed, controller 320 proceeds the processing to step S540 and then causes archive management device 130 to transmit a restoration instruction again (S540). In response to this, restoration acquisition unit 350 acquires new timing of restoration and then updates the entry (S545, S560), so that delay notification unit 360 can transmit a delay message based on the new timing of restoration.

As shown above, controller 320 and delay notification unit 360 can determine whether or not to reply to the request source with a delay message depending on whether the content of an access target is stored in content storage unit 300 or are moved to and stored in archive storage device 140. Specifically, delay notification unit 360 replies to the request source with a delay message in accordance with registration in the status table in table storage unit 330 of the status information indicating delay of content transmission (“ARCHIVED” or “PREPARING,” for example) in association with the content specified by the request message.

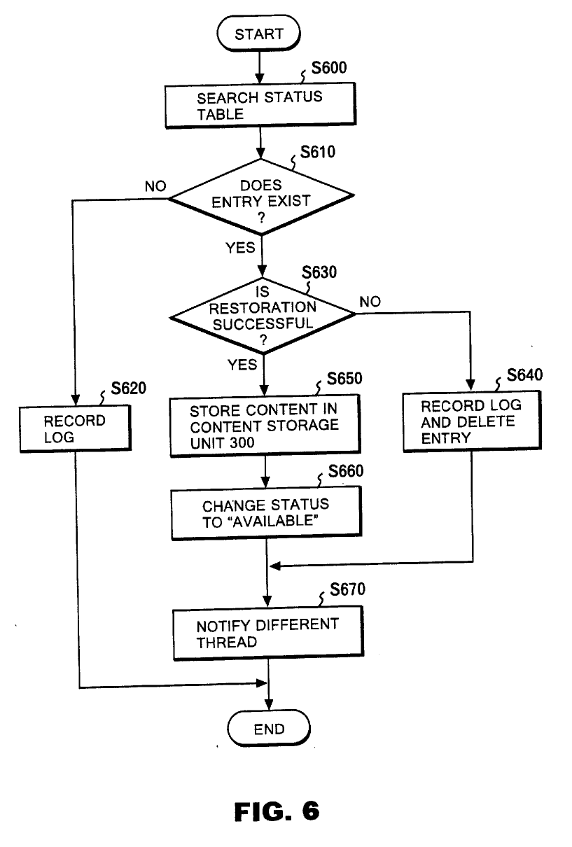

FIG. 6 shows a content restoration processing flow of server apparatus 110 according to the present embodiment. Server apparatus 110 performs the processing shown in FIG. 6 in response to receipt of the restored content from archive management device 130 having received a restoration instruction.

Upon receipt of the restored content, content receiver 370 searches the status table in table storage unit 330 by use of pieces of information transmitted with the restored content as a key, that is, the identification information on archive storage device 140 of archive destination and the storage location within archive storage device 140. Content receiver 370 then specifies the entry corresponding to the content (S600). Here, in a case where a global storage location or global content identification information is received from archive management device 130, content receiver 370 may search the status table by use of the information as the key. In a case where the entry corresponding to the content does not exist, content receiver 370 records the result of the search in an error log and ends the processing (S620). Meanwhile, in a case where the entry corresponding to the content exists (S610: YES), but information indicating failure of the restoration of the content is received from archive storage device 140 (S630: NO), content receiver 370 records the received information in the error log and ends the processing after deleting the entry from the status table (S640).

In a case where the entry corresponding to the content exists (S610: YES), and also the restoration of the content is successful (S630: YES), content receiver 370 stores the restored content in the storage location of the content in content storage unit 300 (S650). Content receiver 370 changes the status information corresponding to the content to “AVAILABLE” (S660). Then, content receiver 370 notifies a different thread running on server apparatus 110 that the status information is changed (S670). Specifically, the different thread is, for example, the thread processing the request message for the content.

According to the processing shown above, server apparatus 110 can receive the restored content from archive management device 130 and then store the restored content in content storage unit 300. In this manner, upon receipt of a request message for the content again, content transmitter 380 can transmit back to the request source the restored content received from archive management device 130.

Note that, instead of the aforementioned processing, server apparatus 110 may forward the content received from archive management device 130 to terminal device 100 of the request source which transmitted the request message, and may then cause terminal device 100 to display the content. Such a push-type content transmission can be accomplished in the following manner, for example. Controller 320 in server apparatus 110 first records, for example, request source identification information for identifying terminal device 100 of a request source in the status table in association with the storage location or content identification information for the content. Then, when the status information changes and shows “AVAILABLE” in response to receipt of the restored content from archive management device 130, controller 320 instructs content transmitter 380 to transmit the content to the request source recorded in the status table. Terminal device 100 having received the restored content is then allowed to display the content after inquiring from the user whether or not to display the content if necessary.

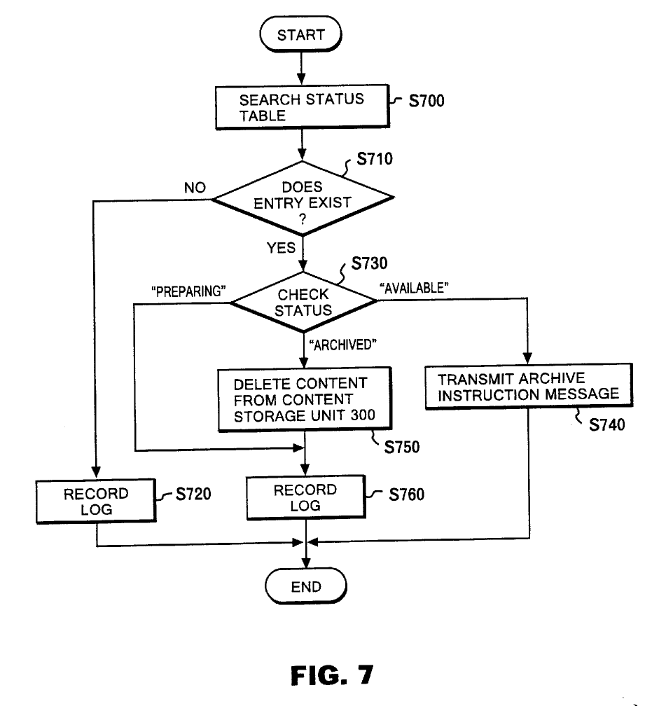

FIG. 7 shows an archive instruction processing flow of server apparatus 110 according to the present embodiment. Server apparatus 110 performs the processing shown in FIG. 7 in a case where content in content storage unit 300 are moved to and stored in an archive storage device 140.

Archive instruction unit 390 determines to archive contents, when the available capacity of content storage unit 300 becomes equal to a previously set reference value or less, for example. Alternatively or additionally, archive instruction unit 390 may select and archive contents periodically or at a predetermined timing.

In addition, archive instruction unit 390 may search for contents that have been referred to at the least recent timing by use of a least recently used (LRU) algorithm and set the found contents as the archive target. In addition, archive instruction unit 390 may search for contents registered in content storage unit 300 before a previously set period of time with the current point of time as the base point, and then sets the found contents as the archive target. Moreover, archive instruction unit 390 may search for contents the reference frequency of which is equal to a previously set reference frequency or less, and then sets the contents as the archive target. Furthermore, archive instruction unit 390 may preferentially select as the archive target the contents assigned a low priority. In addition, archive instruction unit 390 may randomly select the contents of the archive target. Additionally, the contents to be archived may be specified manually. The attributes of contents that are used for selecting the archive target contents may be stored in content storage unit 300 in association with the contents, respectively, or rather may be stored in the status table in table storage unit 330.

Archive instruction unit 390 searches the status table to find an entry corresponding to contents to be archived (S700). In a case where the entry corresponding to the contents to be archived does not exist (S710: NO), archive instruction unit 390 records an error log indicating that the archiving of the contents fails (S720) and then ends this processing.

On the other hand, in a case where the entry corresponding to any of the contents to be archived exists (S710: YES), archive instruction unit 390 transmits an archive instruction message to archive management device 130 (S740) if the status information recorded for the entry is “AVAILABLE” (S730). Here, archive instruction unit 390 determines archive storage device 140 for storing the content and also determines the storage location of the content. Then, archive instruction unit 390 includes, in the archive instruction message, the identification information on determined archive storage device 140 and the determined storage location in archive storage device 140. Alternatively, archive instruction unit 390 may include the storage location of the contents of an archive target or the content identification information in the archive instruction message in order to allow archive management device 130 to specify the contents by use of these pieces of information. Upon receipt of the archive instruction message, archive management device 130 performs archive processing after acquiring the contents from content storage unit 300 via archive instruction unit 390.

If the status information shows “ARCHIVED” in step S730, archive instruction unit 390 deletes the already archived contents from content storage unit 300 (S750). Then, archive instruction unit 390 records a warning log indicating that the contents of the archive target have been already archived (S760) and ends the processing.

If the status information shows “PREPARING” in step S730, this means that the contents are in the process of restoration, so that archive instruction unit 390 records a warning log indicating that the contents of archive target are in the process of restoration (S760) and ends the processing without instructing archive management device 130 to archive the contents.

According to the processing described above, server apparatus 110 can appropriately archive contents in content storage unit 300, thereby preventing capacity shortage of content storage unit 300.

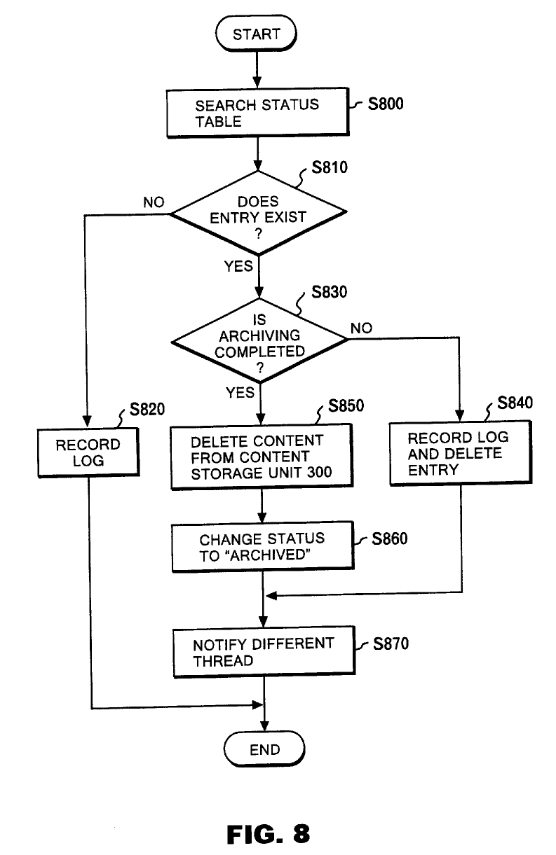

FIG. 8 shows an archive completion processing flow of server apparatus 110 according to the present embodiment. Server apparatus 110 performs the processing shown in FIG. 8 in response to receipt, from archive management device 130, of an archive completion notification or an archive failure notification indicating that the archiving of contents fails.

Upon receipt of the archive completion notification or the archive failure notification, archive instruction unit 390 acquires the identification information on archive storage device 140 and the storage location in archive storage device 140, and searches the status table in content storage unit 300 for entries corresponding to the contents of archive target (S800). In a case where the storage location of the contents or the content identification information is included in these notifications, archive instruction unit 390 may search the status table by use of these pieces of information. In a case where no entry corresponding to the contents exists (S810: NO), archive instruction unit 390 records the result of the search in the warning log(S820) and ends the processing. In a case where the entry corresponding to any of the content exists (S810: YES), but the archiving of the contents fails (S830: NO), archive instruction unit 390 records the failure of the archiving of the contents in the error log and deletes the corresponding entry from the status table (S840). Then, archive instruction unit 390 notifies a different thread running on server apparatus 110 that the entry is deleted (S870).

In a case where the entry corresponding to any of the contents exists (S810: YES), and the archiving of the contents is completed (S830: YES), archive instruction unit 390 increases available storage space of content storage unit 300 by deleting the contents from content storage unit 300 (S850). Then, archive instruction unit 390 changes the status information on the entry to “ARCHIVED” (S860) and notifies a different thread that the status information is changed (S870).

According to the processing shown above, server apparatus 110 deletes the contents from content storage unit 300 after completion of the archiving of the contents. Thus, server apparatus 110 can increase available storage space of content storage unit 300 after confirming that the archiving of the contents is surely completed.

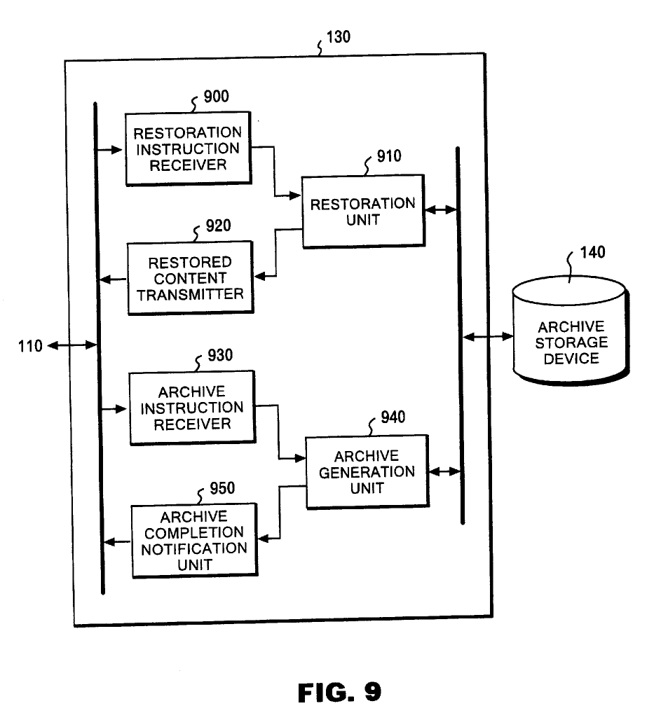

FIG. 9 shows a configuration of archive management device 130 according to the present embodiment together with archive storage device 140. Archive management device 130 includes a restoration instruction receiver 900, a restoration unit 910, a restored content transmission unit 920, an archive instruction receiver 930, an archive generation unit 940 and an archive completion notification unit 950.

Restoration instruction receiver 900 receives a restoration instruction from server apparatus 110. Restoration unit 910 restores the content specified by a restoration instruction from archive data in archive storage device 140. Thereby, in a case where the content specified by the request message received by server apparatus 110 has been moved to and stored in an archive storage device 140, restoration unit 910 can restore the content from archive storage device 140. Restored content transmission unit 920 transmits back to server apparatus 110 the content restored by restoration unit 910.

Archive instruction receiver 930 receives an archive instruction and the content of archive target from server apparatus 110. Archive generation unit 940 generates an archive of the content specified by the archive instruction and stores the archive in an archive storage device 140. Archive completion notification unit 950 transmits an archive completion notification to server apparatus 110 in a case where the generation of the archive is completed. On the other hand, in a case where the generation of the archive fails, archive completion notification unit 950 transmits an archive failure notification to server apparatus 110.

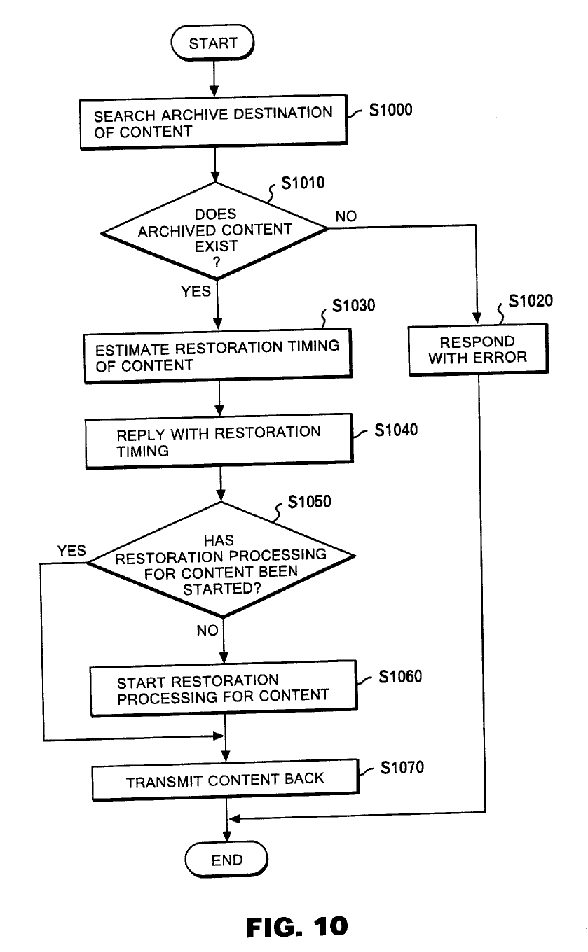

FIG. 10 shows a content restoration processing flow of archive management device 130 according to the present embodiment.

Upon receipt of a restoration instruction from server apparatus 110, restoration instruction receiver 900 provides the restoration instruction to restoration unit 910. In response to the receipt of the restoration instruction, restoration unit 910 searches an archive storage device 140 to become the archive destination of the content (S1000). In this manner, restoration unit 910 performs a search to find out whether or not the content is archived and stored in archive storage device 140. Specifically, the content is specified by the identification information on archive storage device 140 of the archive destination and by the storage location in archive storage device 140, which is included in the restoration instruction.

In a case where the content of a restoration target is not archived in archive storage device 140, restoration unit 910 replies to server apparatus 110 with an error response indicating that the restoration of the content fails via restored content transmission unit 920 (S1020) and ends the processing. On the other hand, in a case where the content of the restoration target is archived in archive storage device 140, restoration unit 910 estimates the timing of restoration of the content (S1030) and notifies server apparatus 110 of the acknowledgment of the restoration instruction together with the estimated timing of restoration via restored content transmission unit 920 (S1040).

Next, restoration unit 910 determines whether or not the process of restoring the content of the restoration target has been already started, for example, due to receipt of a restoration instruction for the same content before this restoration instruction (S1050). In a case where the process of restoring the content has not been started, restoration unit 910 starts the process of restoring the content (S1060). During the process of restoring the content, restoration unit 910 reads out archive data stored in archive storage device 140, then extracts the content of the restoration target from the archive data and then restores the content. Then, restoration unit 910 transmits back to server apparatus 110 via restored content transmitter 920, restored content together with information for specifying the restored content (S1070).

Note that as archive storage device 140 for arching and storing contents, various types of storage devices or a set of storage devices can be used. For example, as archive storage device 140, a set of storage devices such as a disk array may be used in which each of the storage devices is always accessible or is made started and accessible by a command from archive management device 130. In addition, as archive storage device 140, it is also possible to use a storage device that a command from archive management device 130 makes accessible by mechanically causing a recording medium of access target to be inserted into a reading device. The storage device includes a magnetic tape device having a tape changer, an optical or magneto-optical disk device having a disk changer.

In a case where an archive storage device 140 not using a mechanical operation with a tape changer, or disk changer is employed, a period of time needed for the process of restoring content is relatively short. However, during a period between the receipt of a request message and the transmission of the content by server apparatus 110, there may occur processing times of server apparatus 110 and archive management device 130, a wait time in a case where a large number of request messages arrive in a short period of time, a communication time between server apparatus 110 and archive management device 130 that occurs, for example, because server apparatus 110 and archive management device 130 are respectively implemented in different sites via the Internet. Taking these periods of time into consideration, even if a high speed archive storage device 140 is used, it is preferable that server apparatus 110 reply to terminal device 100 of a request source with a delay message at an early timing so that the user does not have to wait.

Moreover, in a case where the content is stored after being compressed or converted into a different data format, restoration unit 910 transmits the content back to terminal device 100 after decompressing or converting the content into the original data format. Accordingly, the load on archive management device 130 becomes high due to the processing. Here, if a large number of request messages are transmitted in a short period of time, the transmission of the content delays due to the increased processing load on archive management device 130. Thus, in server system 10 in which compressed contents are decompressed and then restored by restoration unit 910, it is preferable that delay notification unit 360 reply with a delay message in a case where contents are compressed, even in a server system 10 in which server apparatus 110 and archive management device 130 are implemented by the same server apparatus, and content storage unit 300 and archive storage device 140 are configured of a single storage device.

Furthermore, in a server system 10 that retains content in content storage unit 300 without moving and storing contents in an archive storage device 140, in order to reduce power consumption of the entire server system 10, content storage unit 300 may be turned off or turned into a low power consumption mode while not being accessed. In this case, in response to receipt of a request message for content, server apparatus 110 accesses the content after turning on content storage unit 300 or turning content storage unit 300 into a normal operation mode. Here, server apparatus 110 preferably replies to terminal device 100 with a delay message before transmitting the content back since a wait time occurs for content storage unit 300 to become accessible after turning on the power of content storage unit 300 or changing the operation mode of content storage unit 300.

In contrast to this, in a case where an archive storage device 140 that requires a mechanical operation performed by, for example, a tape changer or a disk changer is employed, replacement of a recording medium requires approximately several seconds to several minutes. Accordingly, in this case in server apparatus 110, by replying with a delay message in advance, it is possible to prevent the user from wrongly determining that the link is broken or that trouble occurs on server apparatus 110.

In addition, as the archive storage device 140 for archiving and storing contents, it is possible to employ a storage device in which recording media such as magnetic tapes or optical/magneto-optical disk are manually changed. In this case, upon receipt of a restoration instruction, archive management device 130 displays to the operator a recording medium in which the content to be restored are stored, and then instructs the operator to insert the recording medium into a reading device. In a case where a recording medium is manually replaced in such a manner, it takes, for example, at least a few minutes, or a few hours or a few days in a longer case to restore the content. If a delay message is not transmitted back during this period of time, the user most likely determines that the content is no longer accessible after attempting to access the content multiple times. In contrast to this, server apparatus 110 according to the present embodiment replies to the user with a delay message when the content is to be restored, so that it is possible for the user to recognize that the content is to surely become accessible, although it requires some time for restoring the content.

As described above, restoration unit 910 can estimate the timing of restoration of each of the contents by use of various methods to be described below as examples. Restoration unit 910 may use a previously set date or time as the estimation time needed for restoring each of the contents, for example. Moreover, restoration unit 910 may measure the time required for restoration of each of the contents and use a restoration time as the estimation time based on the measured values, that is, for example, the average time, the maximum time, or the time needed to complete restoration in a previously set proportion or more. In addition, restoration unit 910 may calculate the estimation time on the basis of the load on archive management device 130, the number of contents waiting for restoration or the whole amount of data of the contents waiting for restoration.

Moreover, restoration unit 910 may change the priority of restoration of contents in accordance with a service level assured for each of the users and may use a different estimation time depending on the service level. In addition, in a case where the content specified by a request message from server apparatus 110 has been moved and stored in any one of a plurality of archive storage devices 140 having different access times, for example, restoration unit 910 may use estimation time in accordance with archive storage device 140 in which the archive of the content has been stored. In this manner, delay notification unit 360 in server apparatus 110 can reply with a delay message displaying to the user the period of time, the date or the time determined on the basis of the period of time required for accessing the storage device to store the content.

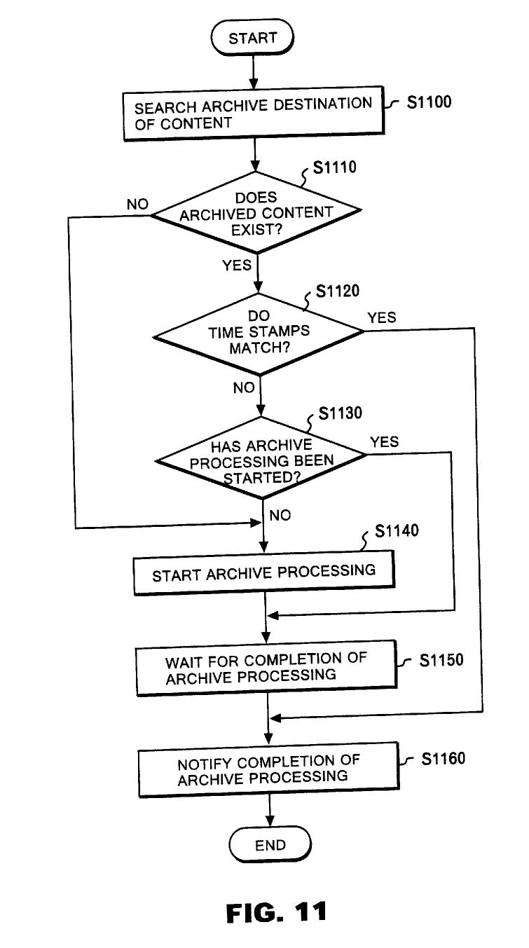

FIG. 11 shows an archive processing flow of archive management device 130 according to the present embodiment.

Upon receipt of an archive instruction from server apparatus 110, archive instruction receiver 930 provides the archive instruction to the archive generation unit 940. In response to the archive instruction, archive generation unit 940 searches archive storage device 140 to be the archive destination of the content (S1100). Archive generation unit 940 searches archive storage device 140 to find out if the content specified by the following information included in the archive instruction has been already archived and stored in archive storage device 140 (S1110). Specifically, the content is specified by archive storage device 140 of the archive destination and the storage location in archive storage device 140.

In a case where the content has not been stored in the specified storage location in the specified archive storage device 140 (S1110: NO), archive generation unit 940 starts the archive processing (S1140). During the archive processing, archive generation unit 940 receives the content of archive target via archive instruction receiver 930, then generates the archive data to store the archive data in archive storage device 140. Archive generation unit 940 may store the content in archive storage device 140 as single archive data, or instead, archive generation unit 940 may add the content of archive target in an archive file collectively including a plurality of contents or files. Furthermore, archive generation unit 940 may compress the contents or change the data format of the contents. Archive generation unit 940 may generate archive data by performing reversible data transformation by which the data can be transformed to have the original data format. Alternatively, archive generation unit 940 may generate the archive data by performing irreversible data transformation such as lowering of the resolution of an image, for example.

During the archive processing, archive generation unit 940 controls a tape changer or a disk changer as appropriate. Furthermore, in a case where a recording medium need to be manually replaced, archive generation unit 940 may display a screen prompting the user to replace the recording medium.

Archive generation unit 940 waits for completion of the archive processing (S1150) and then replies to server apparatus 110 with an archive completion notification via archive completion notification unit 950 (S1160). Here, in a case where the archive processing fails, archive generation unit 940 replies to server apparatus 110 with an archive failure notification.

In step S1110, in a case where a content has already been archived in the specified storage location within specified archive storage device 140 (S1110: YES), archive instruction receiver 930 compares the time stamp of the content required to be archived in accordance with the archive instruction with the time stamp of the content that has already been achieved (S1120). In a case where the time stamps match (S1120: YES), archive generation unit 940 determines that the content of the same data as that of the content of archive target has been already archived, and thus replies to server apparatus 110 with an archive completion notification while omitting the archive processing (S1160).

On the other hand, in a case where the time stamps do not match in step S1120 (S1120: NO), archive generation unit 940 determines whether or not the archive processing of the content of archive target has already been started (S1130). In a case where the archive processing has already been started (S1130: YES), archive generation unit 940 proceeds the processing to S1150. In a case where the archive processing has not been started (S1130: NO), archive generation unit 940 proceeds the processing to step S1140 to start the archive processing.

According to the archive processing shown above, archive management device 130 can omit archive generation in a case where the content of archive target has already been archived. Accordingly, archive management device 130 can avoid unnecessary archive generation.

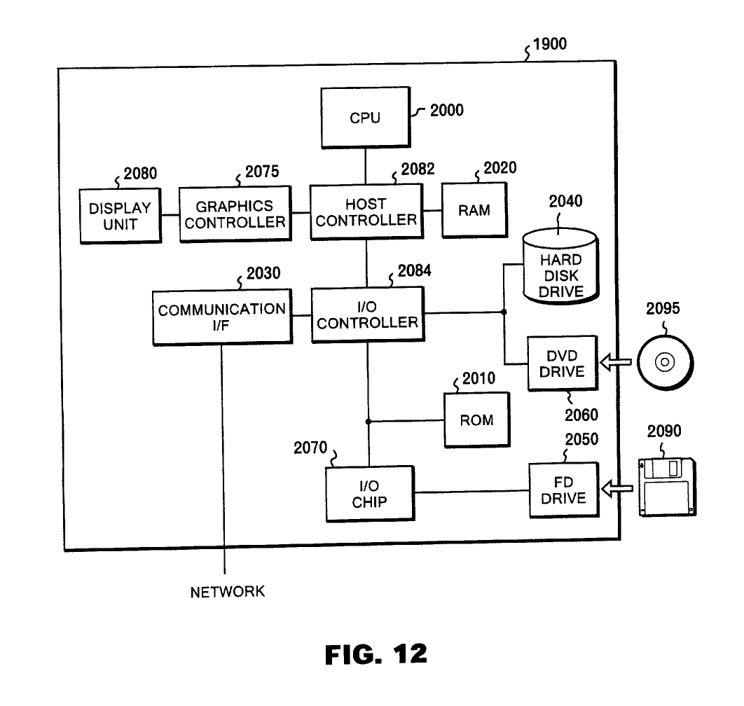

FIG. 12 shows an example of a hardware configuration of a computer 1900 operating as server apparatus 110 and archive management device 130 according to the embodiment. Computer 1900 includes a CPU peripheral unit, an input/output unit and a legacy input/output unit. The CPU peripheral unit includes a CPU 2000, a RAM 2020, a graphics controller 2075 and a display unit 2080, which are connected to one another via a host controller 2082. The input/output unit includes a communication interface 2030, a hard disk drive 2040, and a DVD drive 2060, which are connected to host controller 2082 via an input/output controller 2084. The legacy input/output unit includes a ROM 2010, a flexible disk drive 2050, and an input/output chip 2070, which are connected to input/output controller 2084.

Host controller 2082 connects RAM 2020 with CPU 2000 and graphics controller 2075, which access RAM 2020 at a high transfer rate. CPU 2000 operates on the basis of a program stored in ROM 2010 and RAM 2020, and controls each component. Graphics controller 2075 acquires image data generated by CPU 2000 on a frame buffer provided in RAM 2020, and causes the data to be displayed on display 2080. Alternatively, graphics controller 2075 may be configured to include therein the frame buffer for storing image data generated by CPU 2000.

Input/output controller 2084 connects host controller 2082 with relatively high-speed input/output devices, that is, communication interface 2030, hard disk drive 2040 and DVD drive 2060. Communication interface 2030 communicates with external devices through a network. Hard disk drive 2040 stores therein programs and data that are used by CPU 2000 in computer 1900. DVD drive 2060 reads out programs or data from a DVD 2095, and provides them to hard disk drive 2040 via RAM 2020.

Additionally, input/output controller 2084 also connects ROM 2010 with relatively low-speed input/output devices, that is, flexible disk drive 2050 and input/output chip 2070. ROM 2010 stores therein a boot program executed when computer 1900 is turned on, and/or programs including a program dependent on the hardware of computer 1900. Flexible disk drive 2050 reads out programs or data from a flexible disk 2090, and provides them to hard disk drive 2040 via RAM 2020. Input/output chip 2070 not only connects flexible disk drive 2050 to input/output controller 2084 but also connects various input/output devices to input/output controller 2084 via a parallel port, a serial port, a keyboard port, a mouse port, for example.

Moreover, in computer 1900 operating as archive management device 130, hard disk drive 2040 or DVD drive 2060 may be used as archive storage device 140, or instead of this, an archive storage device 140 having a large capacity may be externally provided. Such archive storage device 140 may be connected to input/output controller 2084 via an expansion interface such as PCI or PCI Express, or via communication interface 2030.

Each program provided to hard disk drive 2040 via RAM 2020 is provided by a user, being stored in a recording medium such as flexible disk 2090, DVD 2095, or an IC card. Each program is read out from the recording medium, installed into hard disk drive 2040 in computer 1900, and then executed by CPU 2000.

A program installed on computer 1900 to cause computer 1900 to function as server apparatus 110 includes a content storage management module for managing content storage unit 300, a request receiving module, a control module, a table storage management module for managing table storage unit 330, a restoration instruction module, a restoration timing acquisition module, a delay notification module, a content receiving module, a content transmitting module and an archive instruction module. The program or the modules operate CPU 2000 and thereby cause computer 1900 to function as content storage unit 300, request receiver 310, controller 320, table storage unit 330, restoration instruction unit 340, restoration timing acquisition unit 350, delay notification unit 360, content receiver 370, content transmitter 380 and archive instruction unit 390.

When loaded onto computer 1900, the above information processing program functions as specific means implemented through cooperation between the software and the aforementioned hardware resources. In other words, the above information processing program functions as request receiver 310, controller 320, restoration instruction unit 340, restoration timing acquisition unit 350, delay notification unit 360, content receiver 370, content transmitter 380 and archive instruction unit 390. Moreover, server apparatus 110 customized in accordance with an intended use of computer 1900 in this embodiment can be built by implementing computation and processing of information in accordance with the intended use by using these specific means.

Furthermore, a program installed on computer 1900 to cause computer 1900 to function as archive management device 130 includes a restoration instruction receiving module, a restoration module, a restored content transmitting module, an archive instruction receiving module, an archive generation module and an archive completion notification module. The program or these modules control CPU 2000 and thereby cause computer 1900 to function as restoration instruction receiver 900, restoration unit 910, restored content transmitter 920, archive instruction receiver 930, archive generation unit 940 and archive completion notification unit 950.

When loaded onto computer 1900, the above information processing program functions as specific means implemented through cooperation between the software and the aforementioned hardware resources. In other words, the above information processing program functions as restoration instruction receiver 900, restoration unit 910, restored content transmitter 920, archive instruction receiver 930, archive generation unit 940 and archive completion notification unit 950. Moreover, archive management device 130 customized in accordance with an intended use of computer 1900 in this embodiment can be built by implementing computation and processing of information in accordance with the intended use by using these specific means.

For example, when computer 1900 communicates with an external device, CPU 2000 executes a communication program loaded on RAM 2020, and instructs communication interface 2030 to perform communication processing on the basis of the processing contents described in the communication program. Under the control of CPU 2000, communication interface 2030 performs a read operation or a write operation as follows. In the read operation, communication interface 2030 reads out transmission data stored in a transmission buffer region provided on a storage unit such as RAM 2020, hard disk drive 2040, flexible disk 2090 or DVD 2095, and then transmits the transmission data via the network. In the write operation, communication interface 2030 writes reception data received via the network into a reception buffer region provided on the storage unit. As described above, the communication interface 2030 may forward or receive data to/from the storage unit by use of a direct memory access (DMA) method. Alternatively, CPU 2000 may read out data from the storage unit or communication interface 2030 of a forwarding-source device, and then write the data into the storage unit or communication interface 2030 of a forwarding-destination device so that data to be exchanged can be forwarded between the devices.

In addition, CPU 2000 loads onto RAM 2020 all or necessary data in files or a database stored in an external storage unit such as hard disk drive 2040, DVD drive 2060 (DVD 2095) or flexible disk drive 2050 (flexible disk 2090) by DMA transfer, and thereby performs various processing on the data on RAM 2020. Then, CPU 2000 rewrites the external storage unit with the processed data by DMA transfer. In the aforementioned processing, RAM 2020 can be considered as a temporary storage unit for data read out from the external storage unit. Thus, RAM 2020, and the external storage are collectively referred to as a memory, a storage unit or a storage device in this embodiment. Various kinds of information including various programs, data, tables, databases in this embodiment are stored in the aforementioned storage unit, and regarded as information processing targets. Note that CPU 2000 may retain part of RAM 2020 in a cache memory, and write or read out data into/from the cache memory. Even in a case where this system is employed, the cache memory performs part of functions of RAM 2020. Thus, the cache memory is also included in RAM 2020, the memory and/or the storage devices in this embodiment, unless the cache memory is described as a distinct unit from these.

In addition, CPU 2000 performs, on data read out from RAM 2020, various processing specified by the sequence of instructions of the program and described in this embodiment, such as various computations, information processing, conditional decision, information search and replacement, and then rewrites RAM 2020 with the processed data. For example, if CPU 2000 performs the conditional decision on the data, CPU 2000 first determines whether or not each of various variables shown in this embodiment satisfies a condition that the variable be larger, smaller, not smaller than, and not larger than or equal to another variable or constant. Then, CPU 2000 branches the processing to a different sequence of instructions or calls a subroutine, if the concerned variable satisfies (or does not satisfy) the condition.

In addition, CPU 2000 is capable of retrieving information stored in files or a database in the storage. For example, consider a case where multiple entries in each of which a first attribute value is associated with a second attribute value are stored in a storage unit. In this case, CPU 2000 searches the storage unit to find out one or more entries having a first attribute value which satisfies a predetermined condition, from the multiple entries stored in the storage unit, and then reads out one or more second attributes stored in the entries. Thereby, CPU 2000 can obtain the second attribute values associated with the first attribute values that satisfy the predetermined condition.

The program or the modules described above may be stored in an external recording medium. In addition to flexible disk 2090 or the DVD 2095, the external recording medium used herein may be an optical recording medium such as a DVD or a CD, a magneto-optical medium such as MO, a tape medium or a semiconductor memory such as an IC card. Alternatively, the external recording medium used herein may be a storage unit such as a hard disk drive or a RAM provided in a server system connected to a dedicated communication network or the Internet. In this case, the program or the modules may be provided to computer 1900 through the network.

Hereinabove, the present invention has been described by using the embodiment. The technical scope of the present invention, however, is not limited to what is described in the above embodiment. It will be apparent to those skilled in the art that the above embodiment can be modified or improved in various ways. It will be apparent from the description of the scope of the claims that such other modified or improved embodiments are also included in the technical scope of the present invention, as well.

It should be noted that the execution sequences of processing such as operations, procedures, steps and stages of a device, system, program and method described in the scope of claims, the specification and the drawings are not clearly specified with the term such as “before” or “prior to,” and therefore the processing may be executed in any sequence unless an output of an earlier process is used in a later process. Moreover, as to the operation flows in the scope of the claims, the description and the drawings, even in a case where a description is given with the terms such as “first” and “next” for the sake of convenience of the description, it does not mean that the operation needs to be performed in this sequence.

In addition, server apparatus 110 and archive management device 130 may be implemented in a single server computer. Moreover, restoration instruction unit 340 in server apparatus 110 may instruct archive management device 130 to restore the content and then to transmit the content back to the request source. Archive management device 130 that has received this instruction transmits the restored content back to terminal device 100 of the request source via the Internet.

Furthermore, server apparatus 110 may use archive management device 130 to process the management of storage destinations of contents instead of using the status table. In other words, table storage unit 330 does not have to retain the identification information on archive storage devices 140 and the storage locations in archive storage devices 140 in the status table shown in FIG. 4. In this case, archive generation unit 940 selects an archive storage device 140 for storing the archive of content and also stores the archive of the content in the selected archive storage device 140 in association with the storage location of the content or the content identification information. Restoration instruction unit 340 transmits, to archive management device 130, a restoration instruction including the storage location of the content in server apparatus 110 or the content identification information. Then, restoration unit 910 searches for the archive of the content of restoration target by use of the storage location of the content or the content identification information included in the restoration instruction, and then restore the archive found by the search. As described, server apparatus 110 and archive management device 130 may receive and pass the storage locations of contents in server apparatus 110 or the content identification information and specify content by use of the information.

Moreover, in order for users to efficiently access contents, server apparatus 110 or archive management device 130 may speculatively execute restoration of contents closely related to a content accessed by a user. For example, in response to receipt of a request message by request receiver 310, restoration unit 910 further restores different contents linked from the content specified by the request message. Furthermore, restoration unit 910 may speculatively restore different contents that can be acquired by sequentially following multiple links (predetermined layers, for example) from the specified content. Moreover, restoration unit 910 may previously generate an archive on a subtree basis in a tree structure of the storage locations of contents or the content identification information, and restore all of the contents that belong to the subtree in a case where a certain content in the subtree are to be restored.

Moreover, restoration unit 910 may store access sequences of each content in a log as statistics information and speculatively restore a content that has been accessed after the content specified by the request message is accessed. Moreover, in a case where a certain user sequentially accesses a plurality of contents, restoration unit 910 speculatively restores contents that have been accessed after the plurality of content are accessed.

Moreover, in order to efficiently accomplish the access of content via a search engine, request receiver 310 may receive a request message including a keyword associated with the content. For example, the keyword is specified by the user for searching the content. Then, in response to receipt of the request message by request receiver 310, restoration unit 910 may further restore different contents that match the keyword included in the request message.

In addition, server system 10 may select whether or not to restore an archived content and then transmit back the content depending on the user. For example, server system 10 may restore content and transmit the content back in response to an access from a user having a predetermined attribute such as a member user, a VIP user or a logged in user even in a case where the content of access target has been archived. On the other hand, in response to an access from a user not having the aforementioned attributes, for example, an access from a non-member user, a non-VIP user or a not logged in user, server system 10 replies with a message indicating that the content does not exist, in a case where the content of access target has been archived.

Although the preferred embodiment of the present invention has been described in detail, it should be understood that various changes, substitutions and alternations can be made therein without departing from spirit and scope of the invention as defined by the appended claims.

What is claimed is:

1. A server system that transmits content back in response to receipt of a request message for the content, the system comprising:
a request receiver for receiving the request message for the content;
a delay notification unit for replying to a request source with a delay message indicating that transmission of the content is to delay;
a restoration unit for restoring the content specified by the request message; and
a content transmitter for transmitting the restored content back to the request source.

2. The server system according to claim 1 further comprising:
a first storage unit including a storage region whose location is specified by the request message; and
a second storage unit requiring a longer access time than the first storage unit, wherein
the delay notification unit replies with the delay message in a case where the content specified by the request message has been moved from the first storage unit to the second storage unit and stored therein, and
the restoration unit restores the content from the second storage unit in the case where the content has been moved from the first storage unit to the second storage unit and stored therein.

3. The server system according to claim 1, wherein:
the delay notification unit replies with the delay message in a case where the content is compressed, and
the restoration unit decompresses the compressed content to restore the content.

4. The server system according to claim 1, wherein the delay notification unit replies with the delay message for causing the request-source terminal device having transmitted the request message to display, to a user thereof, a message indicating that transmission of the content is to delay.

5. The server system according to claim 1, wherein the delay notification unit replies with the delay message for causing the request-source terminal device having transmitted the request message to display, to a user thereof, a message indicating a period of time required for preparing the content, or a date or time at which preparation of the content is completed.

6. The server system according to claim 5, wherein, in a case where the content specified by the request message has been moved to and stored in any one of a plurality of storage units, the delay notification unit replies with the delay message for causing the terminal device to display, to the user, the period of time, the date or the time determined on the basis of a period of time needed for accessing the any one of the plurality of storage units that stores the content therein.

7. The server system according to claim 1, further comprising:
a table storage unit for storing therein a status table in which status information pieces are respectively registered in association with a plurality of the contents, each status information piece indicating whether or not to delay transmission of the associated content, wherein
the delay notification unit replies to the request source with the delay message when the status information piece indicating delay of content transmission is registered in association with the content specified by the request message.

8. The server system according to claim 7, wherein:
for the contents that have been moved from a storage region specified by the request message to a different storage region and stored therein, the table storage unit further stores, in the status table, storage location information pieces indicating storage locations of a storage destination in association with the contents, respectively, and
the restoration unit restores the content stored in the storage location specified by the storage location information piece for the content specified by the request message, the storage location information piece being stored in the status table.

9. The server system according to claim 1, wherein in response to the receipt of the request message by the request receiver, the restoration unit further restores a different content linked from the content specified by the request message.

10. The server system according to claim 1, wherein:
the request receiver receives the request message including a keyword associated with the content, and
in response to the receipt of the request message by the request receiver, the restoration unit further restores a different content that matches the keyword included in the request message.

11. A server apparatus that receives a request message for content from a terminal device of a user, the apparatus comprising:
a request receiver for receiving the request message for the content;
a delay notification unit for replying to a request source with a delay message indicating that transmission of the content is to delay; and
a restoration instruction unit for issuing an instruction for restoring the content specified by the request message.

12. The server apparatus according to claim 11, further comprising a storage unit including a storage region whose location is specified by the request message, wherein:
the delay notification unit replies to the request source with the delay message in a case where the content specified by the request message has been moved from the storage unit to an external storage device and stored therein, and
the restoration instruction unit instructs the external storage device to restore the content.

13. The server apparatus according to claim 12, further comprising:
a content receiver for receiving the restored content from the external storage device; and
a content transmitter for transmitting the restored content back to the request source.

14. The server apparatus according to claim 12, wherein the restoration instruction unit instructs the external storage device to restore the content and then to transmit the restored content back to the request source.

15. A server system that transmits content back in response to receipt of a request message for the content, comprising:
a first storage unit including a storage region whose location is specified by the request message;
a second storage unit requiring a longer access time than the first storage unit;
a table storage unit for storing therein a status table in which status information pieces are respectively registered in association with a plurality of the contents, and in which storage location information pieces are further associated with the respective contents having been moved from the first storage unit to the second storage unit and stored therein, each status information piece indicating whether or not to delay transmission of the associated content, each storage location information piece indicating a storage location of a storage destination of the associated content;
a request receiver for receiving the request message for the content;
a delay notification unit for replying with a delay message for causing the request-source terminal device having transmitted the request message to display, to a user thereof, a period of time required for preparing the content, or a data or time at which preparation of the content is completed, in a case where the content specified by the request message has been moved from the first storage unit to the second storage unit and stored therein, so that the status information piece indicating delay of content transmission is registered in the table storage unit in association with the content specified by the request message;
a restoration unit for restoring the content stored in the storage location in the second storage unit, in a case where the content has been moved to the second storage unit and stored therein, the storage location being specified by the storage location information piece on the content specified by the request message, the storage location information being stored in the status table; and
a content transmitter for transmitting the restored content back to the request-source terminal, wherein
the restoration unit further restores a different content linked from the content specified by the request message.

16. A program for causing a computer to function as a server system that transmits content back in response to receipt of a request message for the content, the program causing the computer to function as:
a request receiver for receiving the request message for the content;
a delay notification unit for replying to a request source with a delay message indicating that transmission of the content is to delay;
a restoration unit for restoring the content specified by the request message; and
a content transmitter for transmitting the restored content back to the request source.

17. A program for causing a computer to function as a server apparatus that receives a request message for content from a terminal device of a user, the program causing the computer to function as:
a request receiver for receiving the request message for the content;
a delay notification unit for replying to a request source with a delay message indicating that transmission of the content is to delay; and
a restoration instruction unit for issuing an instruction for restoring the content specified by the request message.

18. A method of transmitting content back in response to receipt of a request message for the content by use of a computer, the method comprising the steps of:
receiving a request for the content by the computer;
replying to a request source by the computer with a delay message indicating that transmission of the content is to delay;
restoring the content specified by the request message; and
transmitting the restored content back to the request source.

19. A method of causing a computer to operate as a server apparatus that receives a request message for content from a terminal device of a user, the method comprising the steps of:
receiving the request message for the content by the computer;
replying to a request source by the computer with a delay notification message indicating that transmission of the content is to delay; and
issuing an instruction for restoring the content specified by the request message.
